(19) United States
(12) Patent Application Publication
(10) Pub. No.: US 2016/0094824 A1
(43) Pub. Date: Mar. 31, 2016

(54) IMAGE PROCESSING METHOD, IMAGE PROCESSING APPARATUS AND ELECTRONIC DEVICE

(71) Applicant: Sony Corporation, Toyko (JP)

(72) Inventors: Qing YANG, Beijing (CN); Gang XU, Beijing (CN)

(21) Appl. No.: 14/702,823

(22) Filed: May 4, 2015

(30) Foreign Application Priority Data
Sep. 25, 2014 (CN) 201410498556.8

(51) Int. Cl. H04N 9/69; G06T 5/40; H04N 5/335; G06T 7/40; H04N 9/73; G06T 5/00; G06T 5/50

(52) U.S. Cl. CPC H04N 9/69; G06T 5/002; G06T 5/003; G06T 5/009; G06T 5/40; G06T 5/50; G06T 7/408; H04N 9/73; H04N 5/335; G06T 2207/10024; G06T 2207/20182; G06T 2207/20192; G06T 2207/20208; G06T 2207/20224; G06T 2210/61

(57) ABSTRACT

The embodiments of the present application provide an image processing method, an image processing apparatus and an electronic device. The image processing apparatus includes: a shoot scene determination portion configured to determine a shoot scene of an image; an image analysis portion configured to analyze the image to determine a degree of influence of the shoot scene on the shoot quality of the image; and an image processing portion configured to perform a correction processing of the image according to the degree of influence. Through the embodiments of the present application, a correction processing of the image can be performed according to the degree of influence of the shoot scene on the shoot quality of the image, so as to reduce and even eliminate the degree of influence, thus improving the shoot quality of the image.

### CROSS-REFERENCE TO RELATED APPLICATION AND PRIORITY CLAIM

This application claims the benefit of CN Patent Application Serial No. 201410498556.8, filed Sep. 25, 2014, the entire disclosure of which is hereby incorporated by reference.

### TECHNICAL FIELD

The present disclosure relates to the field of image processing, and particularly, to an image processing method, an image processing apparatus and an electronic device.

### BACKGROUND

With the progress of science and technology and the improvement of people's living standards, more and more electronic devices, such as smart phone, tablet PC, digital photo camera, etc., have the image shooting function. Through those electronic devices, the shooting is possible under various shoot scenes.

However, some abnormal shoot scenes (e.g., the light is non-ideal) will influence the shoot quality of the image. In case of an underwater shoot scene, for example the electronic devices may be waterproof in hardware; thus, the user can shoot underwater with the electronic devices, thereby increasing the fun of using the electronic devices. However, unlike taking photos in the air, the light fades very quickly and seriously in the water. Thus, the shooting in the water cannot achieve the same effect as the shooting in the air. In practices, people will find that the contrast, saturation and brightness of the image shot in the water are all unsatisfactory, and many details cannot be presented in the image.

In addition, under some other shoot scenes (e.g., a smoky shoot scene, an overcast and rainy shoot scene, a haze shoot scene, a sand storm shoot scene or a dim shoot scene), the contrast, saturation and brightness of the shot image are also unsatisfactory, and many details cannot be presented in the image.

It should be noted that the above description of the background is merely provided for full and complete explanation of the present application and for easy understanding by those skilled in the art. And it should not be understood that the above technical solution is known to those skilled in the art as it is described in the background art of the present application.

### SUMMARY

The inventor of the present application finds that with the popularity of, for example, the mobile terminal, the shooting in various shoot scenes (e.g., underwater shoot scenes) is increasingly frequent, and the user also has higher and higher requirements for the quality of the images shot in various shoot scenes. Thus, it is necessary to specifically process the images shot in various shoot scenes, so as to improve the quality of the shot image.

The embodiments of the present application provide an image processing method, an image processing apparatus and an electronic device, for the purpose of improving the quality of the images shot in various shoot scenes.

According to a first aspect of the embodiments of the present application, an image processing apparatus is provided, including:

a shoot scene determination portion (the term “portion” may also be referred to and understood throughout this application as module) configured to determine a shoot scene of an image;

an image analysis portion configured to analyze the image to determine a degree of influence of the shoot scene on the shoot quality of the image; and

an image processing portion configured to perform a correction processing of the image according to the degree of influence.

According to a second aspect of the embodiments of the present application, the shoot scene determination portion includes:

a first parameter extraction portion configured to extract a first parameter reflecting features of the image;

a first comparison portion configured to compare the first parameter with a preset first threshold; and

a first judgment portion configured to judge a shoot scene of the image according to a comparison result of the first comparison portion.

According to a third aspect of the embodiments of the present application, the first parameter includes any or a combination of a parameter reflecting color histogram features or grayscale distribution histogram features of the image, a brightness of the image, a sharpness of the image, a saturation of the image, and/or a contrast of the image.

According to a fourth aspect of the embodiments of the present application, the image analysis portion includes:

a second parameter extraction portion configured to extract a second parameter reflecting features of the image; and

an influence degree determination portion configured to determine the degree of influence of the shoot scene on the shoot quality of the image according to the second parameter.

According to a fifth aspect of the embodiments of the present application, the second parameter includes any or a combination of a parameter reflecting color histogram features or grayscale distribution histogram features of the image, a brightness of the image, a sharpness of the image, a saturation of the image, and/or a contrast of the image.

According to a sixth aspect of the embodiments of the present application, the image processing portion includes:

a processing parameter setting portion configured to set a processing parameter required to perform a correction processing of the image according to the degree of influence; and

a processing execution portion configured to perform the correction processing of the image according to the processing parameter set by the processing parameter setting portion.

According to a seventh aspect of the embodiments of the present application, the correction processing of the image performed by the processing execution portion at least includes a gamma correction and/or a histogram adjustment.

According to an eighth aspect of the embodiments of the present application, the shoot scene includes an underwater shoot scene, a smoky shoot scene, an overcast and rainy shoot scene, a haze shoot scene, a sand storm shoot scene or a dim shoot scene.

According to a ninth aspect of the embodiments of the present application, the shoot scene determination portion determines the shoot scene of the image by detecting the image or through a sensor detection.

According to a tenth aspect of the embodiments of the present application, an electronic device is provided, including the aforementioned image processing apparatus.

According to an eleventh aspect of the embodiments of the present application, an image processing method is provided, including:

determining a shoot scene of an image;

analyzing the image to determine a degree of influence of the shoot scene on the shoot quality of the image; and

performing a correction processing of the image according to the degree of influence.

According to a twelfth aspect of the embodiments of the present application, determining a shoot scene of an image includes:

extracting a first parameter reflecting features of the image;

comparing the first parameter with a preset first threshold; and

judging the shoot scene of the image according to a comparison result.

According to a thirteenth aspect of the embodiments of the present application, the first parameter includes any or a combination of a parameter reflecting color histogram features or grayscale distribution histogram features of the image, a brightness of the image, a sharpness of the image, a saturation of the image, and/or a contrast of the image.

According to a fourteenth aspect of the embodiments of the present application, analyzing the image to determine a degree of influence of the shoot scene on the shoot quality of the image includes:

extracting a second parameter reflecting features of the image; and

determining the degree of influence of the shoot scene on the shoot quality of the image according to the second parameter.

According to a fifteenth aspect of the embodiments of the present application, the second parameter includes any or a combination combinations of a parameter reflecting color histogram features of the image, a brightness of the image, a sharpness of the image, a saturation of the image, and/or a contrast of the image.

According to a sixteenth aspect of the embodiments of the present application, performing a correction processing of the image according to the degree of influence includes:

setting a processing parameter required to perform a correction processing of the image according to the degree of influence; and

performing the correction processing of the image according to the processing parameter.

According to a seventeenth aspect of the embodiments of the present application, the performed correction processing of the image at least includes a gamma correction and/or a histogram adjustment.

According to an eighteenth aspect of the embodiments of the present application, the performed correction processing of the image further includes any or a combination combinations of an edge enhancement processing, a noise reduction processing and/or a dark area enhancement processing.

According to a nineteenth aspect of the embodiments of the present application, the shoot scene includes an underwater shoot scene, a smoky shoot scene, an overcast and rainy shoot scene, a haze shoot scene, a sand storm shoot scene or a dim shoot scene.

According to a twentieth aspect of the embodiments of the present application, the shoot scene of the image is determined by detecting the image or through a sensor detection.

The embodiments of the present disclosure have the following beneficial effect: by determining a shoot scene of an image, determining a degree of influence of the shoot scene on the shoot quality of the image, and performing a correction processing of the image according to the degree of influence, the degree of influence of the shoot scene on the shoot quality of the image can be reduced or eliminated, and the quality of the shot image can be improved.

With reference to the following description and drawings, embodiments of the present application are disclosed in detail, and principles of the present application and the manners of use are indicated. It should be understood that the scope of the embodiments of the present application is not limited thereto. The embodiments of the present application contain many alternations, modifications and equivalents within the spirit and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “includes/including” when used in this specification is taken to specify the presence of stated features, integers, steps or components but does not preclude the presence or addition of one or more other features, integers, steps, components or groups thereof.

Many aspects of the present disclosure can be better understood with reference to the drawings. The components in the drawings are not necessarily to scale, emphasis instead being placed upon clearly illustrating the principles of the present disclosure. To facilitate illustrating and describing some parts of the disclosure, corresponding portions of the drawings may be enlarged or reduced. Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF THE DRAWINGS

The drawings are included to provide further understanding of the present disclosure, which constitute a part of the specification and illustrate the preferred embodiments of the present disclosure, and are used for setting forth the principles of the present disclosure together with the description. The same element is represented with the same reference number throughout the drawings.

In the drawings:

FIG. 1 is a structural diagram of an image processing apparatus in Embodiment 1;

FIG. 2 is a structural diagram of a shoot scene determination portion in Embodiment 1;

FIG. 3 is a comparative diagram of color histograms of RGB images shot in the water and air;

FIG. 4 is a structural diagram of an image analysis portion in Embodiment 1;

FIG. 5 is a structural diagram of an image processing portion in Embodiment 1;

FIG. 6 is a structural diagram of a processing execution portion in Embodiment 1;

FIG. 7 is a comparative diagram of the effects before and after a processing of an image shot in the water made by an image processing apparatus of the Embodiment 1;

FIG. 8 is a flow diagram of an image processing method in Embodiment 2;

FIG. 9 is another flow diagram of an image processing method in Embodiment 2;

FIG. 10 is a flow diagram of determining a shoot scene in Embodiment 2;

FIG. 11 is a flow diagram of determining a degree of influence of a shoot scene on the shoot quality of an image in Embodiment 2;

FIG. 12 is a flow diagram of performing an image correction processing in Embodiment 2;

FIG. 13 is a block diagram of a system construction of an electronic device in Embodiment 3.

### DESCRIPTION OF THE EMBODIMENTS

Various embodiments of the present application are described as follows with reference to the drawings. Those embodiments are just exemplary, rather than limitations to the present application. The interchangeable terms “electronic device” and “electronic apparatus” include a portable radio communication device. The term “portable radio communication device”, which is hereinafter referred to as “mobile radio terminal”, “portable electronic apparatus”, or “portable communication apparatus”, includes all devices such as mobile phone, pager, communication apparatus, electronic organizer, personal digital assistant (PDA), smart phone, portable communication apparatus, etc.

In the present application, the embodiments of the present disclosure are mainly described with respect to a portable electronic apparatus in the form of a mobile phone (also referred to as “cellular phone”). However, it shall be appreciated that the present disclosure is not limited to the case of the mobile phone and it may relate to any type of appropriate electronic device, such as mobile terminal, media player, gaming device, PDA and computer, digital video camera, tablet PC, wearable electronic device, etc.

### Embodiment 1

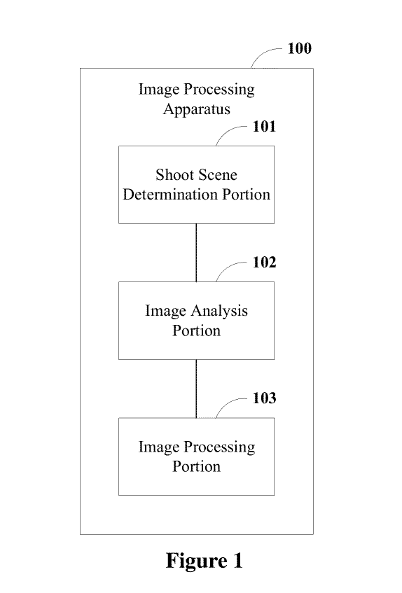

Embodiment 1 of the present application provides an image processing apparatus for processing an image. FIG. 1 is a structural diagram of an image processing apparatus in Embodiment 1. As illustrated in FIG. 1, the image processing apparatus 100 includes a shoot scene determination portion 101 (the term “portion” may also be referred to and understood throughout this application as module), an image analysis portion 102 and an image processing portion 103.

The shoot scene determination portion 101 is configured to determine a shoot scene of an image. The image analysis portion 102 is configured to analyze the image to determine a degree of influence of the shoot scene on the shoot quality of the image. The image processing portion 103 is configured to perform a correction processing of the image according to the degree of influence.

In this embodiment, the image processing apparatus 100 may correct the images under various shoot scenes. For example, the shoot scene may be a situation where the light is non-ideal, such as a dim shoot scene due to insufficient light; or a situation of light attenuation, like an underwater shoot scene, due to light propagation in a propagation medium; or a situation of light diffusion or light reflection, like a smoky shoot scene, caused by impurities in a propagation medium.

In this embodiment, the shoot scene, for example, may include an underwater shoot scene, a smoky shoot scene, an overcast and rainy shoot scene, a hazy shoot scene, a sand storm shoot scene or a dim shoot scene. But the present disclosure is not limited thereto, and other shoot scenes may also be possible. Next, the present disclosure will be described in details by taking the underwater shoot scene as an example.

In this embodiment, the image processing apparatus 100 may be configured in a waterproof mobile terminal, and an image acquiring member of the mobile terminal may acquire the image. The mobile terminal for example may be a camera, a smart phone, a tablet PC, a wearable device, etc., and the image acquiring member for example may be a CCD image sensor, etc., but the present disclosure is not limited thereto. The mobile terminal may control the image sensor to acquire the image by shooting underwater. The image processing apparatus may process the acquired image, thereby obtaining a corrected image in real time.

For example, in the underwater shoot scene, the mobile terminal may obtain a parameter related to the pressure or the light through a pressure sensor or a light sensor. The shoot scene determination portion 101 in the image processing apparatus 100 may determine whether it is in the underwater shoot scene by judging whether the parameter is larger than a preset threshold. When it is in the underwater shoot scene, the image analysis portion 102 and the image processing portion 103 correct the image shot by the video camera.

Alternatively, in the underwater shoot scene, the mobile terminal may obtain an image through the image sensor. The shoot scene determination portion 101 in the image processing apparatus 100 may analyze the image to determine whether it is in the underwater shoot scene. When it is in the underwater shoot scene, the image analysis portion 102 and the image processing portion 103 correct the shot image.

In addition, the image processing apparatus may also be provided in an electronic device which is not a mobile terminal, such as a Personal Computer (PC). The electronic device may acquire the image from, for example, a waterproof photo camera through a network, a USB interface, a Bluetooth interface, etc. The image processing apparatus may process the acquired image, thereby obtaining a corrected image in non-real time.

The following descriptions are just made through an example where the image processing apparatus is provided in the mobile terminal, but the present disclosure is not limited thereto.

In this embodiment, the image processing apparatus 100 may perform a correction processing of the image according to the degree of influence of the underwater shoot scene on the shoot quality of the image, so as to reduce or eliminate the degree of influence. Thus, the quality of the image shot underwater can be improved.

Next, the specific structures of the components of the image processing apparatus 100 will be described with reference to the drawings.

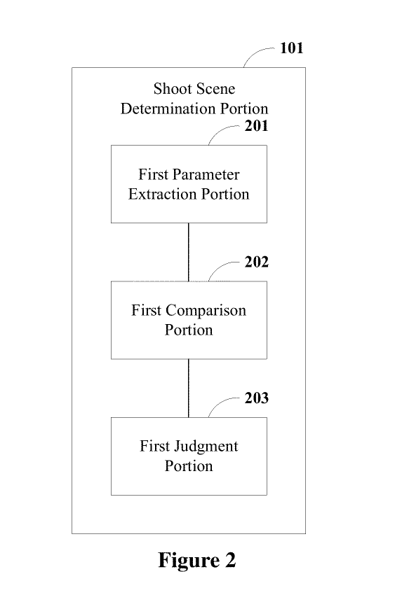

FIG. 2 is a structural diagram of a shoot scene determination portion in Embodiment 1. As illustrated in FIG. 2, the shoot scene determination portion 101 may include a first parameter extraction portion 201, a first comparison portion 202 and a first judgment portion 203.

The first parameter extraction portion 201 is configured to extract a first parameter reflecting features of the image; the first comparison portion 202 is configured to compare the first parameter with a preset first threshold; and the first judgment portion 203 is configured to judge a shoot scene of the image according to a comparison result of the first comparison portion.

In this embodiment, the first parameter extraction portion 201 may detect the image, and extract a first parameter reflecting features of the image, wherein when the image is a color image, the first parameter, for example, may be a parameter reflecting color histogram features of the image, and when the image is a grayscale image, the first parameter for example may be a parameter reflecting grayscale distribution histogram features of the image.

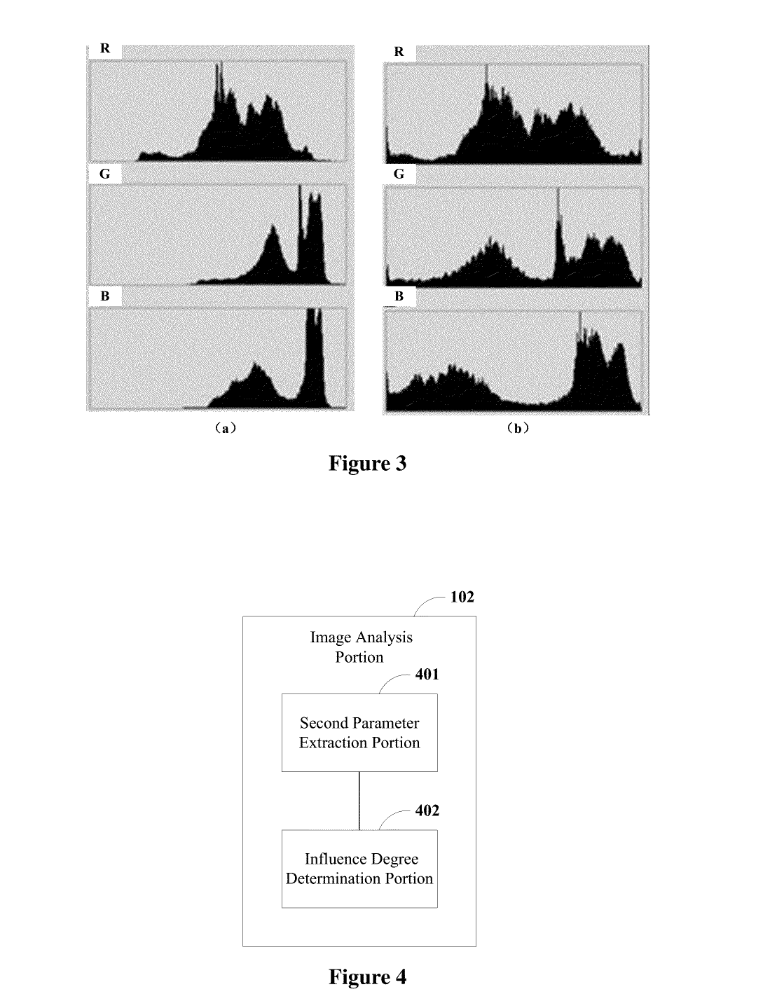

FIG. 3 is a comparative diagram of color histograms of RGB images shot in the water and air, wherein FIG. 3 (b) is corresponding to an image shot in the air, and FIG. 3 (a) is corresponding to an image shot in the water. As illustrated in FIG. 3, R, G and B represent color histograms of red (R), green (G) and blue (B) channels of the image, respectively, wherein in the color histogram of each channel, the horizontal axis represents the grayscale value of the pixel, for example in a range of 0 to 256 from left to right, the color being close to white when the grayscale value increases, and the longitudinal axis represents the number of pixels corresponding to a certain grayscale value in the channel of the color.

As can be seen from FIG. 3, when the image is shot in the air, the pixels are distributed in the entire grayscale range of 0 to 256 in the color histogram of each channel; and when the image is shot underwater, the pixels are only distributed in a middle area of the grayscale range. That is, when the image is shot underwater, the distribution of the pixels on the horizontal axis is narrowed in the color histogram.

The reason of the phenomenon is that the contrast of the image is decreased due to the effects of light scattering, absorption and refraction by the water, thus the difference between the grayscales of the pixels in the image becomes unobvious. As a result, the grayscale values of the pixels are focused in a middle area of the color histogram. Thus, it can be determined whether the image is shot in the underwater shoot scene according to the width of pixel distribution on the horizontal axis in the color histogram.

In addition, the above analysis is also applicable to the grayscale distribution histogram of the grayscale image, i.e., the image shot in the water has a narrower width of pixel distribution on the horizontal axis in the grayscale distribution histogram than the image shot in the air.

Based on the above features, in the embodiment of the present application, when the image is an RGB image, the first parameter extraction portion may extract a width of pixel distribution in the color histogram as a parameter reflecting features of the color histogram. For example, the first parameter extraction portion 201 may detect the color histogram of the R, G or B channel of the image, and calculate a width of pixel distribution on the horizontal axis in the color histogram as the first parameter.

In addition, this embodiment is not limited thereto. The first parameter extraction portion 201 may extract those widths in two or three of the color histograms of the R, G and B channels, and combine the widths to obtain the first parameter. For example, the combination manner for example may be a simple arithmetic or weighted adding, but the present application is not limited thereto.

In addition, when the image is a grayscale image, the first parameter extraction portion may extract a width of pixel distribution in the grayscale distribution histogram as a parameter reflecting features of the grayscale distribution histogram.

The above descriptions just take the color histogram and the grayscale distribution histogram as examples. In this embodiment, the extraction manner of the first parameter is not limited thereto. For example, in addition to the parameter reflecting features of the color histogram or the grayscale distribution histogram, the first parameter extraction portion 201 may further extract any one or more of parameters such as brightness, sharpness, saturation or contrast of the image, and combine the extracted parameters to obtain the first parameter. The combination manner, for example, may be a simple arithmetic or weighted adding, but the present application is not limited thereto, and, for example, an averaging operation may also be performed.

In addition, the above descriptions just take RGB colors as examples, and the present disclosure is not limited thereto. For example, the YUV mode, the YCbCr mode, the HSV mode or the HIS mode may also be used.

In this embodiment, the first parameter may be inputted into the first comparison portion 202 that compares the first parameter with a preset first threshold and outputs a comparison result. For example, the first threshold may be predetermined, or adjusted through an external device according to the user operation, thereby continuously optimizing the threshold.

In this embodiment, the first judgment portion 203 may judge whether the shoot scene of the image is underwater according to the comparison result. For example, the first parameter is the width of pixel distribution on the horizontal axis in the color histogram of the R channel of the image, and it is 134, while the preset threshold is 198. When the first parameter is smaller than or equal to the first threshold, it can be judged that the shoot scene of the image is underwater. In that case, the image analysis portion 102 may be started.

When the first parameter is larger than the first threshold, it can be judged that the shoot scene of the image is not underwater. In that case, the image analysis portion 102 may not be started, and instead, other processing of the image may be performed. For example, the image may be processed in a manner opposite to the result of the correction processing by the image processing portion 103, e.g., an underwater shoot effect is added to the image, or other image processing may be performed.

To be noted, the above analysis of the image indicates how to judge an underwater shoot scene, but the descriptions of the shoot scene determination portion 101 herein are just exemplary, and the shoot scene determination portion 101 may have other structure. For example, the shoot scene determination portion 101 may detect a signal of a capacitive pressure sensor array in an image shooting apparatus, and judges whether the image shooting apparatus shoots the image underwater according to the signal of the capacitive pressure sensor array.

FIG. 4 is a structural diagram of an image analysis portion in Embodiment 1. As illustrated in FIG. 4, the image analysis portion 102 may include a second parameter extraction portion 401 and an influence degree determination portion 402, wherein the second parameter extraction portion 401 extracts a second parameter reflecting features of the image, and the influence degree determination portion 402 determines the degree of influence of the shoot scene on the shoot quality of the image according to the second parameter.

In this embodiment, the second parameter extraction portion 401 may analyze the image to extract the second parameter. For example, the second parameter may be one or a combination of a parameter reflecting features of a color histogram or a grayscale distribution histogram of the image, brightness of the image, saturation of the image, sharpness of the image and/or contrast of the image. But the present application is not limited thereto, and other parameter may also be possible.

In this embodiment, the second parameter may be different from the first parameter. For example, the first parameter may be a width of pixel distribution in the color histogram of the R channel, and the second parameter may be a sharpness of the image. Alternatively, the first parameter may be obtained by weighted adding the brightness, saturation and sharpness of the image with a first group of weighting coefficients, and the second parameter may be obtained by weighted adding the brightness, saturation and sharpness of the image with a second group of weighting coefficients, wherein the first group of weighting coefficients are different from the second group of weighting coefficients.

The above descriptions are just exemplary, but this embodiment is not limited thereto, and the second parameter may also be other parameter or a combination of parameters reflecting features of the image. Moreover, in this embodiment, the second parameter may also be the same as the first parameter. In that case, the second parameter extraction portion 401 may directly use the first parameter as the second parameter. The first parameter and the second parameter may be determined according to the actual scene.

The first parameter extraction portion 201 and the second parameter extraction portion 401 are described as above respectively, but the present disclosure is not limited thereto. For example, the same member may be used to extract parameters reflecting features of the image, and then those parameters may be applied to the shoot scene determination and the image analysis, respectively, e.g., the parameters may be extracted at one time and used for several times.

In this embodiment, the influence degree determination portion 402 may determine a degree of influence of the shoot scene on the image according to the second parameter. Thus, the degree of influence of the factors such as water depth, water clarity, weather fairness on the shoot quality for example in the underwater shoot scene can be reflected comprehensively.

In this embodiment, the influence degree determination portion 402 may determine the degree of influence of the shoot scene on the image in multiple manners. For example, the degree of influence may be quantized as influence factors of different values, and the second parameter is the width of pixel distribution on the horizontal axis in the color histogram of the R channel of the image. If the value of the second parameter is between 0 and 50, the influence factor may be determined as 1; if the value of the second parameter is between 50 and 100, the influence factor may be determined as 2; if the value of the second parameter is between 100 and 150, the influence factor may be determined as 3; if the value of the second parameter is between 150 and 200, the influence factor may be determined as 4; and if the value of the second parameter is between 200 and 256, the influence factor may be determined as 5.

The influence degree determination portion 402 may determine an influence factor corresponding to the second parameter according to a preset function of the second parameter and the influence factor (e.g., a linear function y=ax+b, wherein y is the influence factor, x is the value of the second parameter, while a and b are preset constants); or the influence degree determination portion 402 may determine the influence factor corresponding to the second parameter according to a preset look-up table of the second parameter and the influence factor (e.g., in the look-up table, the values of a plurality of second parameters are one-by-one corresponding to a plurality of influence factors); or the influence degree determination portion 402 may compare the second parameter with a plurality of preset second thresholds, and determine the influence factor corresponding to the second parameter according to a comparison result.

In the above example, the function, the look-up table and the plurality of second thresholds may be preset or adjusted through an external device according to the user operation, so as to be optimized. To be noted, the above descriptions are just exemplary, and the manner of determining the degree of influence is not limited thereto.

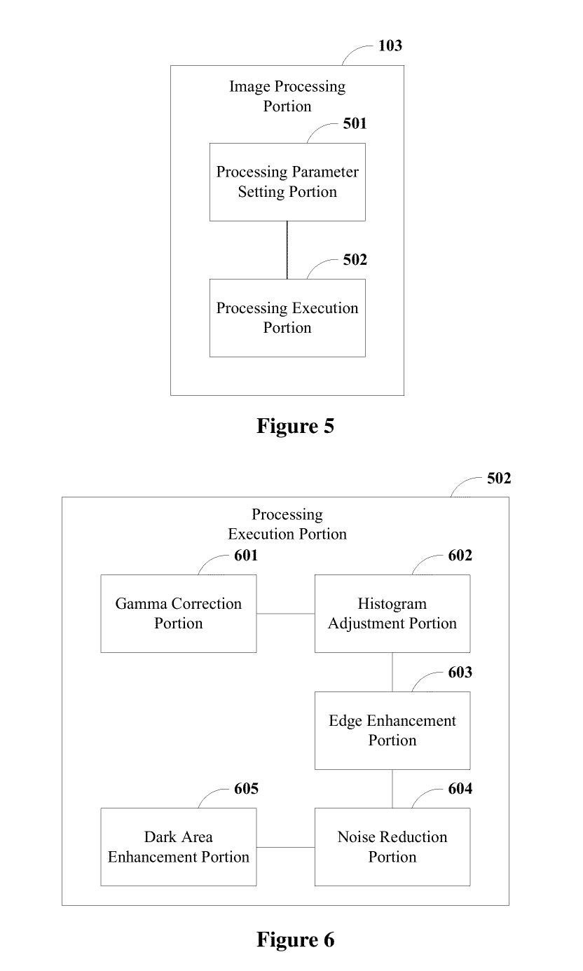

FIG. 5 is a structural diagram of an image processing portion in Embodiment 1. As illustrated in FIG. 5, the image processing portion 103 may include a processing parameter setting portion 501 and a processing execution portion 502, wherein the processing parameter setting portion 501 sets a processing parameter required to perform a correction processing of the image according to the degree of influence; and the processing execution portion 502 performs a correction processing of the image according to the processing parameter set by the processing parameter setting portion.

In this embodiment, the processing parameter setting portion 501 may set the processing parameter required to perform a correction processing according to the influence factor determined by the influence degree determination portion 402. In addition, the set processing parameter enables a reduction or elimination of the degree of influence through the correction processing.

In this embodiment, the processing parameter setting portion 501 may set the processing parameter according to correspondence between the influence factor and the processing parameter.

For example, the processing parameter setting portion 501 may set the parameter according to a preset function of the influence factor and the processing parameter (e.g., a linear function y′=cx′+d, wherein y′ is the processing parameter, x′ is the influence factor, while c and d are preset constants); or the processing parameter setting portion 501 may set the processing parameter according to a preset look-up table of the influence factor and the processing parameter (e.g., in the look-up table, the values of a plurality of processing parameters are one-by-one corresponding to a plurality of influence factors); or the processing parameter setting portion 501 may compare the influence factor with a plurality of preset third thresholds, and set the processing parameter according to a comparison result.

In the above example, the function, the look-up table and the plurality of third thresholds may be preset or adjusted through an external device according to the user operation, so as to be optimized.

The above descriptions of this embodiment are just exemplary, and the manner of setting the processing parameter is not limited thereto. Other manners are also possible, e.g., the set parameter may be adjusted according to the user's setting operation, so that the subsequent correction processing meets the user's individual needs.

In this embodiment, the processing parameter, for example, may be a gamma parameter for a gamma correction, and/or a parameter for a histogram adjustment (e.g., the threshold of boundary detection for the grayscale focused interval). The parameter for the histogram adjustment may be used in an adjustment for the grayscale image, or adjustments for RGB channels of the color image, respectively (meanwhile, it is also adaptive to color images represented with other color space, such as YUV, YCbCr, HSV and HSI). But this embodiment is not limited thereto and other parameters for the correction processing may also be used.

In this embodiment, the processing execution portion 502 performs a correction processing according to the processing parameter set by the processing parameter setting portion 501. The correction processing performed by the processing execution portion 502 at least may include a gamma correction and a histogram adjustment. In which, the histogram adjustment may include an adjustment of color histogram and/or an adjustment of grayscale distribution histogram. In addition, the correction processing may further include one or more of an edge enhancement, a noise reduction or a dark area enhancement.

FIG. 6 is a structural diagram of a processing execution portion in Embodiment 1. As illustrated in FIG. 6, the processing execution portion 502 may include a gamma correction portion 601, a histogram adjustment portion 602, an edge enhancement portion 603, a noise reduction portion 604 and a dark area enhancement portion 605.

The gamma correction portion 601 may be configured to compensate for the color attenuation effect of the water. In addition, as for the RGB image, a gamma correction may be performed for the R, G and B channels of the image, respectively. As for the grayscale image, a gamma correction may be performed for the grayscale of the image. As for the underwater color image, the gamma value may be set according to the statistical saturation of the image. For example, the underwater image is usually blue-green, and according to the statistical information of the three channels of the image, it can be found that the red channel usually has a very low saturation. Thus, during the adjustment, the gamma correction parameter of the red channel can be appropriately increased to ensure that the red information is saturated in the recovered image.

The histogram adjustment portion 602 can improve the contrast of the image, and reflect the details of the image better. In addition, as for the RGB image, the histograms of the R, G and B channels thereof may be adjusted respectively. As for the grayscale image, the grayscale distribution histogram thereof may be adjusted. As for the underwater color image, the grayscale distributions of the R, G and B channels are all compressed, i.e., the higher and low orders of grayscale information is absent, and the grayscale information is focused in the middle area (the actual distribution area is influenced by the image content and the environment brightness). Thus the histogram adjustment portion 602 may calculate the grayscale focused interval based on a preset threshold of boundary detection for the grayscale focused interval and information of the grayscale distribution histograms of the R, G and B channels, and then perform a histogram stretching or histogram equalization processing thereof, so as to obtain a processed image of an enhanced contrast and enriched details.

In addition, the edge enhancement portion 603 may be configured to highlight an edge in the image where there is a large difference between the brightness of adjacent areas, so as to clearly display the boundaries of different areas. The noise reduction portion 604 may be configured to reduce the noise in the process of image shooting and processing. For example, a noise reduction processing may be performed by constructing a mean filter, a median filter, an adaptive filter, etc. The dark area enhancement portion 605 may be configured to perform a grayscale enhancement processing of a dark area (e.g., an area having a low grayscale value) in the image, so as to improve the local contrast of the image. In addition, as for the RGB image, a dark area enhancement may be performed for the R, G and B channels thereof, respectively; and as for the grayscale image, a dark area enhancement may be performed for the grayscale of the image.

In this embodiment, the processing orders of the above portions 601-605 can be adjusted upon demand. In addition, the processing execution portion 502 does not necessarily include all of the above portions 601-605, and for example it may only include some of them. However, in order to ensure the correction quality, the processing execution portion 502 may at least include a gamma correction portion 601 and a histogram adjustment portion 602 in any embodiment.

The degree of influence of the underwater shoot scene on the shoot quality of the image is reduced and even eliminated through the processing by the processing execution portion 502, thereby improving the quality of the image shot underwater.

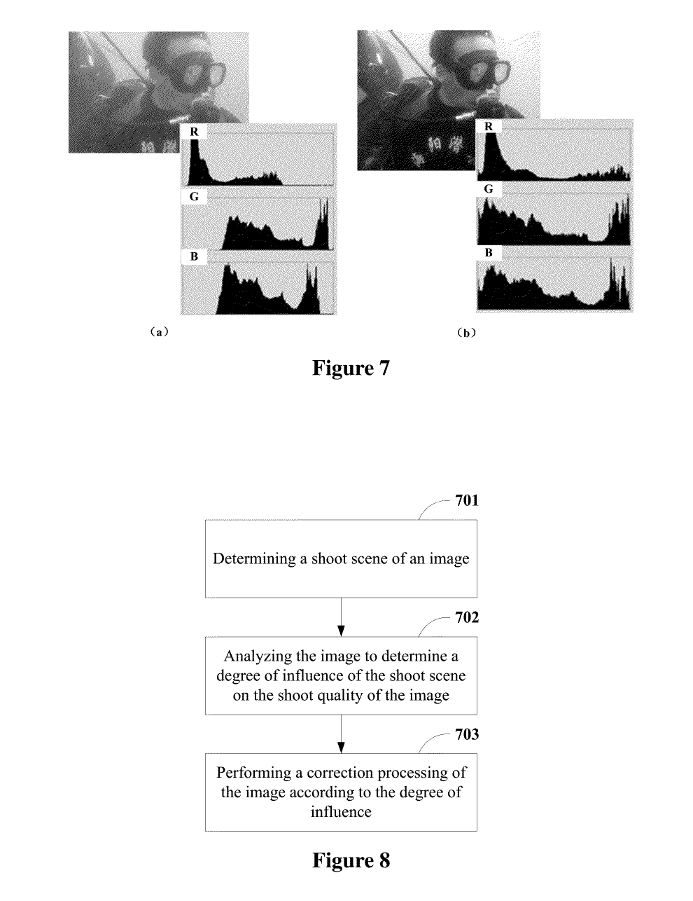

FIG. 7 is a comparative diagram of the effects before and after a processing of an image shot in the water made by an image processing apparatus of the embodiment, wherein FIG. 7 (a) is corresponding to a display effect and a color histogram of the image before the processing, and FIG. 7(b) is corresponding to a display effect and a color histogram of the image after the processing.

As illustrated in FIG. 7, viewed from the display effect of the image, the contrast of the image after the processing is enhanced, and the details are clearer. Viewed from the color histogram, in the image after the processing, the pixel grayscale distribution of each channel is widened, and the grayscales corresponding to pixel peak values of various channels are close to each other; in the image before the processing, the pixel grayscale distribution of each channel is narrower, and the grayscales corresponding to pixel peak values of various channels are inconsistent with each other.

In addition, a single image is taken as an example herein, but this embodiment is not limited thereto. The image processing apparatus 100 can also perform the above image processing for each frame in the video image, thereby performing an image processing for the video image.

In addition, the present application is also applicable to the underwater view-finding processing in real time by the photographic device, wherein a 30 fps (frames per second) underwater image processed in real time may be obtained by performing a processing of less than or equal to 30 ms (milliseconds) for each frame of underwater image; a 60 fps underwater image processed in real time may be obtained by performing a processing of less than or equal to 16 ms for each frame of underwater image; a 120 fps high-speed underwater image processed in real time may be obtained by performing a processing of less than or equal to 8 ms for each frame of underwater image; and so on.

In the application example of the processing of the underwater image in real time, the processing algorithm may be simplified on the premise that the correction effect is sacrificed in a certain extent, so as to simplify the parameters and solidify the variable parameters. Meanwhile, the present application is also applicable to the key frame processing technology, i.e., with respect to the underwater detection effect of a certain frame, the parameter calculations and settings for image enhancement and restoration can be followed in subsequent several frames, thereby reducing the whole calculation amount and improving the processing speed.

To be noted, the present disclosure is described in details by taking the underwater shoot scene as an example, but the present disclosure is not limited thereto. For example, the present disclosure may also be applicable to a smoky shoot scene, an overcast and rainy shoot scene, a haze shoot scene, a sand storm shoot scene or a dim shoot scene, etc. Under those shoot scenes, the above parameters, thresholds or correction algorithms may be adaptively adjusted, so as to obtain a better processing effect.

In this embodiment, the image processing apparatus 100 can determine the shoot scene of the image and the degree of influence of the shoot scene on the shoot quality of the image, and perform a correction processing of the image according to the degree of influence, so as to reduce and even eliminate the degree of influence, thus improving the shoot quality of the image.

### Embodiment 2

Embodiment 2 of the present application provides an image processing method for processing an image, which is corresponding to the image processing apparatus of Embodiment 1, and the same contents are omitted herein.

FIG. 8 is a flow diagram of an image processing method in Embodiment 2. As illustrated in FIG. 8, the image processing method includes:

Step 701: determining a shoot scene of an image;

In this embodiment, the shoot scene of the image may be determined by detecting the image or through a sensor detection.

Step 702: analyzing the image to determine a degree of influence of the shoot scene on the shoot quality of the image; and

Step 703: performing a correction processing of the image according to the degree of influence.

In this embodiment, the shoot scene may include an underwater shoot scene, a smoky shoot scene, an overcast and rainy shoot scene, etc. Next, the present disclosure will be further described by taking the underwater shoot scene as an example.

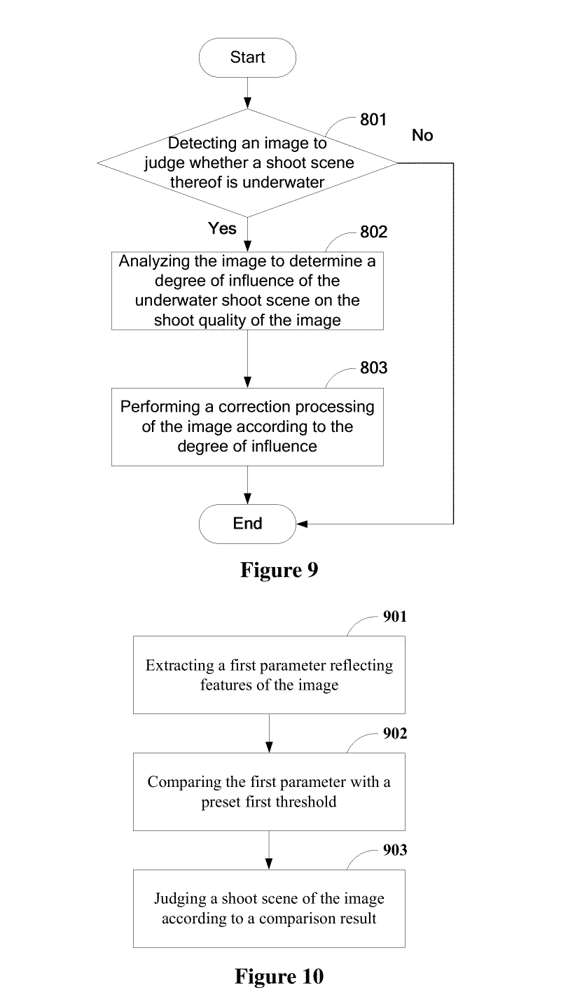

FIG. 9 is another flow diagram of an image processing method in Embodiment 2. As illustrated in FIG. 9, the image processing method includes:

Step 801: detecting an image to judge whether a shoot scene thereof is underwater; if so, performing step 802; and if not, the method of this embodiment may be ended, while for example the conventional image processing method may be adopted, which is not described herein.

In this embodiment, the detection may be performed by using the shoot scene determination portion 101 as described in Embodiment 1. In addition, the step may also be performed using the method for detecting hardware device, e.g., a sensor may be used to detect a potential variation of the capacitive screen in the mobile terminal, so as to judge whether the mobile terminal is in an underwater environment, and then decide whether to start the underwater mode.

The hardware device is not limited to the sensor which detects the capacitive screen, and, for example, it also may be a proximity sensor, an ambient light sensor, etc. Through the hardware device detection, the image calculation amount can be reduced and the whole processing speed can be improved. The hardware detection may also serve as auxiliary mechanism (or module) and/or method to detect whether the device is underwater, so as to improve the whole detection accuracy.

In this embodiment, the sensor may be any or a combination of an acceleration sensor, a proximity sensor, a temperature sensor, a speed sensor, a barometric pressure sensor, a geomagnetic sensor, a deformation sensor, a humidity sensor and/or a light sensor, but the present disclosure is not limited thereto.

In addition, it may be detected whether a device is in an underwater environment by detecting an attenuation degree of the received electromagnetic signal (sent by the device or by a third party) since the electromagnetic signal has different attenuation degrees in different mediums (e.g., the attenuation degree or speed in the water is far more than that in the air), wherein the electromagnetic signal for example may be a Bluetooth signal, a WIFI signal, an NFC signal and other electromagnetic signal.

In addition, the environment (i.e., water or air) where the device is located may be detected since the light has different total reflection critical angles in different mediums. For example, the total reflection angle may be detected using an optical fiber or other refracting medium. The light source may be any laser transmitting device or other light having a good directional property. For another example, a pressure or pressure intensity detection may be performed using the optical fiber, thus different environments where the device is located can be detected since the pressure intensity is different in the water and air.

In this embodiment, for example when an underwater detection is performed, the mobile terminal may perform an associative detection with other apparatus, including data sharing of the sensors and communications therebetween. Other apparatus for example may include a wearable device, a smart watch, a bracelet, smart glasses, smart helmet, etc., but the present disclosure is not limited thereto.

In this embodiment, the image may be detected in real time, i.e., it is detected whether the shoot scene is underwater while the image is shot. In addition, the image may be detected in non-real time, i.e., it is detected whether the shoot scene is underwater after the image is shot.

Step 802: analyzing the image to determine a degree of influence of the underwater shoot scene on the shoot quality of the image; Please refer to Embodiment 1 for the analysis and the determination of the degree of influence in this embodiment.

Step 803: performing a correction processing of the image according to the degree of influence;

Please refer to Embodiment 1 for the correction processing in this embodiment.

Thus, the degree of influence of the underwater shoot scene on the shoot quality of the image can be reduced and even eliminated, and the quality of the image shot underwater can be improved. Next, the steps will be described in details.

FIG. 10 is a flow diagram of step 801 in Embodiment 2. As illustrated in FIG. 10, step 801 may include:

Step 901: extracting a first parameter reflecting features of the image;

Step 902: comparing the first parameter with a preset first threshold; and

Step 903: judging a shoot scene of the image according to a comparison result.

The first parameter may include any or a combination of a parameter reflecting color histogram features or grayscale distribution histogram features of the image, a brightness of the image, a sharpness of the image, a saturation of the image, and/or a contrast of the image.

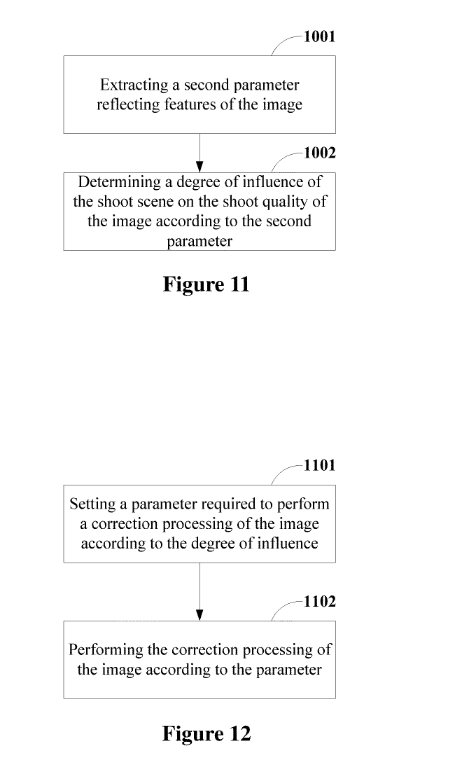

FIG. 11 is a flow diagram of step 802 in Embodiment 2. As illustrated in FIG. 11, step 802 may include:

Step 1001: extracting a second parameter reflecting features of the image; and

Step 1002: determining a degree of influence of the shoot scene on the shoot quality of the image according to the second parameter.

The second parameter may include any or a combination of a parameter reflecting color histogram features or grayscale distribution histogram features of the image, a brightness of the image, a sharpness of the image, a saturation of the image, and/or a contrast of the image.

In addition, the first parameter and the second parameter may be the same as or different from each other in this embodiment.

FIG. 12 is a flow diagram of step 803 in Embodiment 2. As illustrated in FIG. 12, step 803 may include:

Step 1101: setting a parameter required to perform a correction processing of the image according to the degree of influence; and

Step 1102: performing the correction processing of the image according to the parameter.

The performed correction processing of the image may include any or combination of a gamma correction, a color histogram adjustment and/or a grayscale distribution histogram adjustment. In addition, the correction processing may further include one or more of an edge enhancement, a noise reduction and/or a dark area enhancement.

Please refer to the working modes of corresponding units in Embodiment 1 for the working modes of the steps in this embodiment, which are omitted herein.

In this embodiment, the image processing method can determine the shoot scene of the image and the degree of influence of the shoot scene on the shoot quality of the image, and perform a correction processing of the image according to the degree of influence, so as to reduce and even eliminate the degree of influence, thus improving the shoot quality of the image.

### Embodiment 3

Embodiment 3 of the present application provides an electronic device, including an image processing apparatus as described in Embodiment 1. Next, the electronic device will be described by taking a mobile terminal as an example, but the present application is not limited thereto.

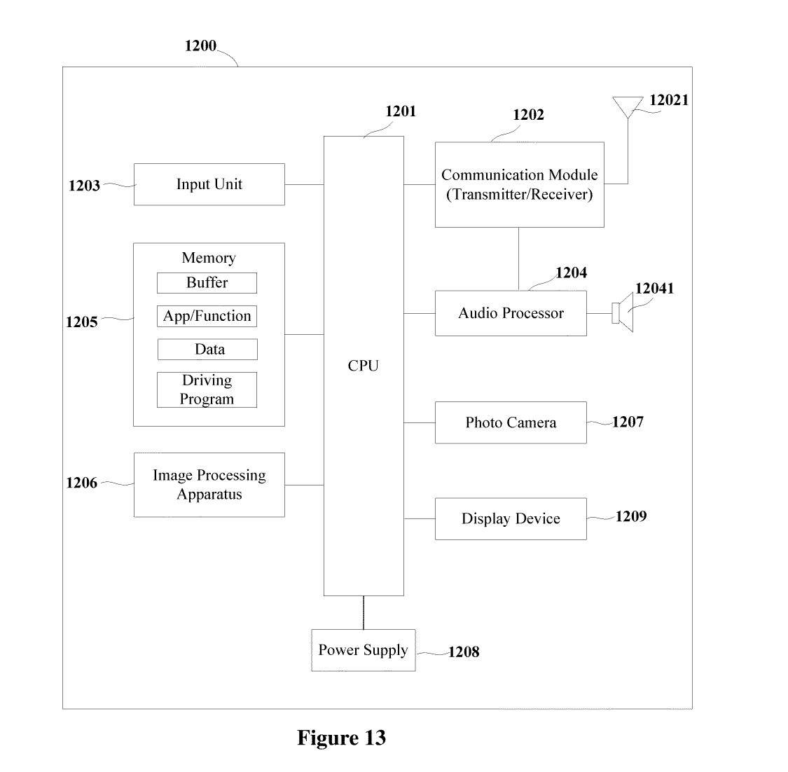

FIG. 13 is a block diagram of a system construction of an electronic device 1200 in Embodiment 3, including an image processing apparatus as described in Embodiment 1. To be noted, FIG. 13 is exemplary, and other type of structure may also be used to supplement or replace the structure, so as to realize the telecom function or other function.

As illustrated in FIG. 13, the electronic device 1200 may include a Central Processing Unit (CPU) 1201, a communication module 1202, an input unit 1203, an audio processor 1204, a memory 1205, an image processing apparatus 1206, a photo camera 1207 and a power supply 1208, wherein the working principle of the image processing apparatus 1206 is the same as that of the image processing apparatus 100 in Embodiment 1, which is omitted herein.

In this embodiment, the image processing apparatus 1206 may be configured separately from the CPU 1200, e.g., being configured as a chip connected to the CPU 1201, so as to realize the function of the image processing apparatus 1206 under the control of the CPU.

In this embodiment, the image processing apparatus 1206 may not be provided individually, and instead, the functions thereof are integrated into the CPU 1201. The CPU 1201 may be configured to control to: determine a shoot scene of an image; analyze the image to determine a degree of influence of the shoot scene on the shoot quality of the image; and perform a correction processing of the image according to the degree of influence.

In addition, the CPU 1201 may also be configured to control to: extract a first parameter reflecting features of the image; compare the first parameter with a preset first threshold; and judge a shoot scene of the image according to a comparison result, wherein the first parameter includes any or combination of a parameter reflecting color histogram features or grayscale distribution histogram features of the image, a brightness of the image, a sharpness of the image, a saturation of the image, and/or a contrast of the image.

In addition, the CPU 1201 may also be configured to control to: extract a second parameter reflecting features of the image; and determine a degree of influence of the shoot scene on the shoot quality of the image according to the second parameter, wherein the second parameter includes any or combination of a parameter reflecting color histogram features of the image, a brightness of the image, a sharpness of the image, a saturation of the image, and/or and a contrast of the image.

In addition, the CPU 1201 may also be configured to control to: set a processing parameter required to perform a correction processing of the image according to the degree of influence; and perform a correction processing of the image according to the processing parameter, wherein the performed correction processing of the image at least includes a gamma correction, a color histogram adjustment and/or a grayscale distribution histogram adjustment.

As illustrated in FIG. 13, the CPU 1201 sometimes is called as controller or operation control, and it may include a microprocessor or other processor device and/or logic device. The CPU 1201 receives an input and controls the respective parts and operations of the electronic device 1200.

The communication module 1202 is a transmitter/receiver which transmits and receives a signal via an antenna 12021. The communication module is coupled to the CPU, so as to supply an input signal and receive an output signal, which may be the same as the situation of the conventional mobile communication terminal.

On the basis of different communication technologies, the same electronic device may be provided with a plurality of communication modules 1202, such as a cellular network module, a Bluetooth module and/or a wireless local area network (WLAN) module. The communication module is further coupled to a speaker 12041 via an audio processor 1204, so as to provide an audio output via the speaker 12041. The audio processor 1204 may include any appropriate buffer, decoder, amplifier, etc.

The input unit 1203 provides an input to the CPU 1201. The input unit 1203 for example is a key or a touch input device.

The photo camera 1207 is configured to shoot and provide image data to the CPU for a conventional usage, such as storage and transmission.

The power supply 1208 is configured to supply electric power to the electronic device 1200. A display device 1209 displays objects such as images, videos and texts.

The memory 1205 is coupled to the CPU 1201. The memory 1205 may be a solid state memory, such as Read Only Memory (ROM), Random Access Memory (RAM), SIM card, etc., or a memory which stores information even if the power is off, which can be selectively erased and provided with more data, and the example of such a memory is sometimes called an EPROM, etc. The memory 1205 also may be a certain device of other type. The memory 1205 includes a buffer memory (sometimes called as buffer), and an application/function storage portion which stores application programs and function programs or performs the operation procedure of the electronic device 1200 via the CPU 1201.

The memory 1205 may further include a data storage portion which stores data such as the preset function, look-up table, first to third thresholds, etc. in Embodiment 1. A drive program storage portion of the memory may include various drive programs of the electronic device for performing the communication function and/or other functions (e.g., messaging application, address book application, etc.) of the electronic device.

The embodiment of the present disclosure further provides a computer readable program, which when being executed in an electronic device, enables a computer to perform the image processing method described in Embodiment 2 in the electronic device.

The embodiment of the present disclosure further provides a storage medium storing a computer readable program, wherein the computer readable program enables a computer to perform the image processing method described in Embodiment 2 in an electronic device.

The preferred embodiments of the present disclosure are described as above with reference to the drawings. Many features and advantages of those embodiments are apparent from the detailed Specification, thus the accompanied claims intend to cover all such features and advantages of those embodiments which fall within the true spirit and scope thereof. In addition, since numerous modifications and changes are easily conceivable to a person skilled in the art, the embodiments of the present disclosure are not limited to the exact structures and operations as illustrated and described, but cover all suitable modifications and equivalents falling within the scope thereof.

It shall be understood that each part of the present disclosure may be implemented by hardware, software, firmware, or combinations thereof. In the above embodiments, multiple steps or methods may be implemented by software or firmware stored in the memory and executed by an appropriate instruction executing system. For example, if the implementation uses hardware, it may be realized by any one of the following technologies known in the art or combinations thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

Any process, method or block in the flowchart or described in other manners herein may be understood as being indicative of including one or more modules, segments or parts for realizing the codes of executable instructions of the steps in specific logic functions or processes, and that the scope of the preferred embodiments of the present disclosure included other implementations, wherein the functions may be executed in manners different from those shown or discussed (e.g., according to the related functions in a substantially simultaneous manner or in a reverse order), which shall be understood by a person skilled in the art.

The logic and/or steps shown in the flowcharts or described in other manners here may be, for example, understood as a sequencing list of executable instructions for realizing logic functions, which may be implemented in any computer readable medium, for use by an instruction executing system, apparatus or device (such as a system based on a computer, a system including a processor, or other systems capable of extracting instructions from an instruction executing system, apparatus or device and executing the instructions), or for use in combination with the instruction executing system, apparatus or device.

The above literal descriptions and drawings show various features of the present disclosure. It shall be understood that a person of ordinary skill in the art may prepare suitable computer codes to carry out each of the steps and processes described above and illustrated in the drawings. It shall also be understood that the above-described terminals, computers, servers, and networks, etc. may be any type, and the computer codes may be prepared according to the disclosure contained herein to carry out the present disclosure by using the apparatus.

Particular embodiments of the present disclosure have been disclosed herein. A person skilled in the art will readily recognize that the present disclosure is applicable in other environments. In practice, there exist many embodiments and implementations. The appended claims are by no means intended to limit the scope of the present disclosure to the above particular embodiments. Furthermore, any reference to “an apparatus configured to . . . ” is an explanation of apparatus plus function for describing elements and claims, and it is not desired that any element using no reference to “an apparatus configured to . . . ” is understood as an element of apparatus plus function, even though the wording of “apparatus” is comprised in that claim.

Although a particular preferred embodiment or embodiments have been shown and the present disclosure has been described, it is obvious that equivalent modifications and variants are conceivable to a person skilled in the art in reading and understanding the description and drawings. Especially for various functions executed by the above elements (parts, components, apparatus, and compositions, etc.), except otherwise specified, it is desirable that the terms (including the reference to “apparatus”) describing these elements correspond to any element executing particular functions of these elements (i.e. functional equivalents), even though the element is different from that executing the function of an exemplary embodiment or embodiments illustrated in the present disclosure with respect to structure. Furthermore, although the a particular feature of the present disclosure is described with respect to only one or more of the illustrated embodiments, such a feature may be combined with one or more other features of other embodiments as desired and in consideration of advantageous aspects of any given or particular application.

1. An image processing apparatus, comprising:
a shoot scene determination portion configured to determine a shoot scene of an image;
an image analysis portion configured to analyze the image to determine a degree of influence of the shoot scene on the shoot quality of the image; and
an image processing portion configured to perform a correction processing of the image according to the degree of influence.

2. The image processing apparatus according to claim 1, wherein the shoot scene determination portion comprises:
a first parameter extraction portion configured to extract a first parameter reflecting features of the image;
a first comparison portion configured to compare the first parameter with a preset first threshold; and
a first judgment portion configured to judge a shoot scene of the image according to a comparison result of the first comparison portion.

3. The image processing apparatus according to claim 2, wherein the first parameter comprises any or a combination of a parameter reflecting color histogram features or grayscale distribution histogram features of the image, a brightness of the image, a sharpness of the image, a saturation of the image, or a contrast of the image.

4. The image processing apparatus according to claim 1, wherein the image analysis portion comprises:
a second parameter extraction portion configured to extract a second parameter reflecting features of the image; and
an influence degree determination portion configured to determine the degree of influence of the shoot scene on the shoot quality of the image according to the second parameter.

5. The image processing apparatus according to claim 4, wherein the second parameter comprises any or a combination of a parameter reflecting color histogram features or grayscale distribution histogram features of the image, a brightness of the image, a sharpness of the image, a saturation of the image, or a contrast of the image.

6. The image processing apparatus according to claim 1, wherein the image processing portion comprises:
a processing parameter setting portion configured to set a processing parameter required to perform a correction processing of the image according to the degree of influence; and
a processing execution portion configured to perform the correction processing of the image according to the processing parameter set by the processing parameter setting portion.

7. The image processing apparatus according to claim 1, wherein the correction processing of the image performed by the processing execution portion at least comprises a gamma correction and/or a histogram adjustment.

8. The image processing apparatus according to claim 1, wherein the shoot scene comprises an underwater shoot scene, a smoky shoot scene, an overcast and rainy shoot scene, a haze shoot scene, a sand storm shoot scene or a dim shoot scene.

9. The image processing apparatus according to claim 1, wherein the shoot scene determination portion determines the shoot scene of the image by detecting the image or through a sensor detection.

10. An electronic device, comprising an image processing apparatus according to claim 1.

11. An image processing method, comprising:
determining a shoot scene of an image;
analyzing the image to determine a degree of influence of the shoot scene on the shoot quality of the image; and
performing a correction processing of the image according to the degree of influence.

12. The image processing method according to claim 11, wherein determining a shoot scene of an image comprises:
extracting a first parameter reflecting features of the image;
comparing the first parameter with a preset first threshold; and
judging the shoot scene of the image according to a comparison result.

13. The image processing method according to claim 12, wherein the first parameter comprises any or a combination of a parameter reflecting color histogram features or grayscale distribution histogram features of the image, a brightness of the image, a sharpness of the image, a saturation of the image, or a contrast of the image.

14. The image processing method according to claim 11, wherein analyzing the image to determine a degree of influence of the shoot scene on the shoot quality of the image comprises:
extracting a second parameter reflecting features of the image; and
determining the degree of influence of the shoot scene on the shoot quality of the image according to the second parameter.

15. The image processing method according to claim 14, wherein the second parameter comprises any or a combination of a parameter reflecting color histogram features of the image, a brightness of the image, a sharpness of the image, a saturation of the image, or a contrast of the image.

16. The image processing method according to claim 11, wherein performing a correction processing of the image according to the degree of influence comprises:
setting a processing parameter required to perform a correction processing of the image according to the degree of influence; and
performing the correction processing of the image according to the processing parameter.

17. The image processing method according to claim 11, wherein the performed correction processing of the image at least comprises a gamma correction and/or a histogram adjustment.

18. The image processing method according to claim 17, wherein the performed correction processing of the image further comprises any or a combination of an edge enhancement processing, a noise reduction processing or a dark area enhancement processing.

19. The image processing method according to claim 11, wherein the shoot scene comprises an underwater shoot scene, a smoky shoot scene, an overcast and rainy shoot scene, a haze shoot scene, a sand storm shoot scene or a dim shoot scene.

20. The image processing method according to claim 11, wherein the shoot scene of the image is determined by detecting the image or through a sensor detection.
